(19) United States
(12) Patent Application Publication
(10) Pub. No.: US 2025/0028221 A1
(43) Pub. Date: Jan. 23, 2025

(54) CASCADABLE PHOTONIC CIRCUIT WITH SEMICONDUCTOR OPTICAL AMPLIFIER BASED AMPLITUDE THRESHOLDER

(71) Applicant: Milkshake Technology Inc., Kingston (CA)

(72) Inventors: Bicky A. Marquez, Ontario (CA); Joshua Baxter, Ontario (CA); Ahmed Khaled, Ontario (CA); Alireza Samani, Ontario (CA); Bhavin J. Shastri, Ontario (CA); Douglas H. Wightman, Ontario (CA)

(21) Appl. No.: 18/225,032

(22) Filed: Jul. 21, 2023

(51) Int. Cl. G02F 3/00

(52) U.S. Cl. CPC G02F 3/00

(57) ABSTRACT

A photonic circuit with a semiconductor optical amplifier-based amplitude thresholder for correcting bit errors produced by a passive photonic logic. In addition to the amplitude thresholder, the photonic circuit further includes a plurality of photonic inputs receiving photonic input signals, a first cascaded series of photonic components coupled to the photonic inputs, and a second cascaded series of photonic components coupled to the amplitude thresholder. The first cascaded series of photonic components generates a plurality of intermediate photonic output signals based on the photonic input signals. The amplitude thresholder generates a saturated photonic signal based on a first of the plurality of intermediate photonic output signals when the amplitude thresholder operates in a single nonlinear region. The second cascaded series of photonic components generates a photonic output signal based at least in part on a second of the plurality of intermediate photonic output signals and the saturated photonic signal.

### TECHNICAL FIELD

The present disclosure generally relates to a processor architecture and, more specifically, to a cascadable photonic circuit with a semiconductor optical amplifier-based amplitude thresholder.

### BACKGROUND

Photonic hardware is favorable for applications requiring high bandwidth, low latency, and low switching energy for signal processing, data communications, and information processing (i.e., computing). Recent innovations in silicon photonic fabrication have enabled the on-chip implementation of photonic circuits. This has opened a low-cost, high-precision, and scalable avenue for the development of photonic computing. Advances in photonic computing have demonstrated suitability for applications requiring high-bandwidth parallel processing, especially neural networks, offering higher speed and less energy consumption than equivalent networks implemented in digital or analog electronics.

Circuitry for photonic computing typically employs cascaded passive photonic gates. Different phases of optical signals (i.e., light signals) processed by a passive photonic gate can cause amplitude errors and/or phase errors at an output of the passive photonic gate. Furthermore, these amplitude errors and/or phase errors can propagate and accumulate through photonic circuitry that includes cascaded passive photonic gates.

### SUMMARY

Embodiments of the present disclosure are directed to the implementation of a photonic circuit that utilizes a semiconductor optical amplifier (SOA) based amplitude thresholder for correction of amplitude errors and/or phase errors produced by passive photonic logic. The photonic circuit comprises a plurality of photonic inputs configured to receive a plurality of photonic input signals, a first cascaded series of photonic components coupled to the plurality of photonic inputs, an amplitude thresholder coupled to the first cascaded series of photonic components, and a second cascaded series of photonic components coupled to the first cascaded series of photonic components and the amplitude thresholder. The first cascaded series of photonic components is configured to generate a plurality of intermediate photonic output signals based on the plurality of photonic input signals. The amplitude thresholder is configured to generate a saturated photonic signal based on a first of the plurality of intermediate photonic output signals when the amplitude thresholder operates in a single nonlinear region. The second cascaded series of photonic components configured to generate a photonic output signal based at least in part on a second of the plurality of intermediate photonic output signals and the saturated photonic signal.

Embodiments of the present disclosure are further directed to a non-transitory computer-readable storage medium comprising stored instructions that, when executed by at least one processor, cause the at least one processor to: instruct a plurality of photonic inputs of a photonic circuit to receive a plurality of photonic input signals; instruct a first cascaded series of photonic components of the photonic circuit coupled to the plurality of photonic inputs to generate a plurality of intermediate photonic output signals based on the plurality of photonic input signals; instruct an amplitude thresholder of the photonic circuit coupled to the first cascaded series of photonic components to generate a saturated photonic signal based on a first of the plurality of intermediate photonic output signals when the amplitude thresholder operates in a single nonlinear region; and instruct a second cascaded series of photonic components of the photonic circuit coupled to the first cascaded series of photonic components and the amplitude thresholder to generate a photonic output signal based at least in part on a second of the plurality of intermediate photonic output signals and the saturated photonic signal. The non-transitory computer-readable storage medium can be a digital storage medium, an analog storage medium, an optical storage medium, some other type of storage medium, or some combination thereof. The at least one processor can be an optical processor, an electronic processor (e.g., central processing unit (CPU) processor, machine-learning (ML) processor, graphics processing unit (GPU) processor), some other type of processor, or some combination thereof.

Embodiments of the present disclosure are further directed to a method for operating a photonic circuit that utilizes a SOA-based amplitude thresholder for correction of amplitude errors and/or phase errors produced by a passive photonic logic. The method comprises: receiving, at a plurality of photonic inputs of the photonic circuit, a plurality of photonic input signals; generating, by a first cascaded series of photonic components of the photonic circuit coupled to the plurality of photonic inputs, a plurality of intermediate photonic output signals based on the plurality of photonic input signals; generating, by an amplitude thresholder of the photonic circuit coupled to the first cascaded series of photonic components, a saturated photonic signal based on a first of the plurality of intermediate photonic output signals when the amplitude thresholder operates in a single nonlinear region; and generating, by a second cascaded series of photonic components of the photonic circuit coupled to the first cascaded series of photonic components and the amplitude thresholder, a photonic output signal based at least in part on a second of the plurality of intermediate photonic output signals and the saturated photonic signal.

### BRIEF DESCRIPTION OF THE DRAWINGS

FIG. 1 illustrates an example cascadable photonic circuit that includes a semiconductor optical amplifier (SOA) based amplitude thresholder, in accordance with some embodiments.

FIG. 2A illustrates an example graph of transfer functions of a SOA-based amplitude thresholder, in accordance with some embodiments.

FIG. 2B illustrates an example generalized graph of a transfer function of a SOA-based amplitude thresholder represented as a piece-wise function, in accordance with some embodiments.

FIG. 3A illustrates an example XOR logic operation of the cascadable photonic circuit in FIG. 1, in accordance with some embodiments.

FIG. 3B illustrates an example graph of a transfer function of the SOA-based amplitude thresholder of the XOR logic operation in FIG. 3A, in accordance with some embodiments.

FIG. 4 is a flowchart illustrating an example method for operating a photonic circuit with a SOA-based amplitude thresholder, in accordance with some embodiments.

The figures depict embodiments of the present disclosure for purposes of illustration only. One skilled in the art will readily recognize from the following description that alternative embodiments of the structures and methods illustrated herein can be employed without departing from the principles or benefits touted by the disclosure described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that can be employed without departing from the principles of what is claimed.

Reference will now be made in detail to several embodiments, examples of which are illustrated in the accompanying figures. It is noted that wherever practicable, similar or like reference numbers can be used in the figures and can indicate similar or like functionality. The figures depict embodiments of the disclosed system (or method) for illustration only. One skilled in the art will readily recognize from the following description that alternative embodiments of the structures and methods illustrated herein can be employed without departing from the principles described herein.

Embodiments of the present disclosure are directed to the implementation of a cascadable photonic circuit (i.e., photonic logic gate) that utilizes a semiconductor optical amplifier (SOA) based amplitude thresholder to correct errors (e.g., amplitude errors and/or phase errors) produced by a passive photonic logic within the photonic circuit. A photonic logic gate (e.g., exclusive ‘OR’ (XOR) photonic gate) presented herein utilizes the SOA-based amplitude thresholder as a nonlinear photonic component for correction of amplitude errors and/or phase errors produced by the passive photonic logic. A cascadable XOR photonic gate presented in this disclosure is implemented by utilizing photonic beam splitters, photonic combiners, photonic phase shifters, and a SOA-based amplitude thresholder that operates in a single nonlinear region. The XOR photonic gate presented herein produces correct output results without any errors and can be directly cascaded with other photonic gates within a photonic processor.

### Cascadable Photonic Circuit

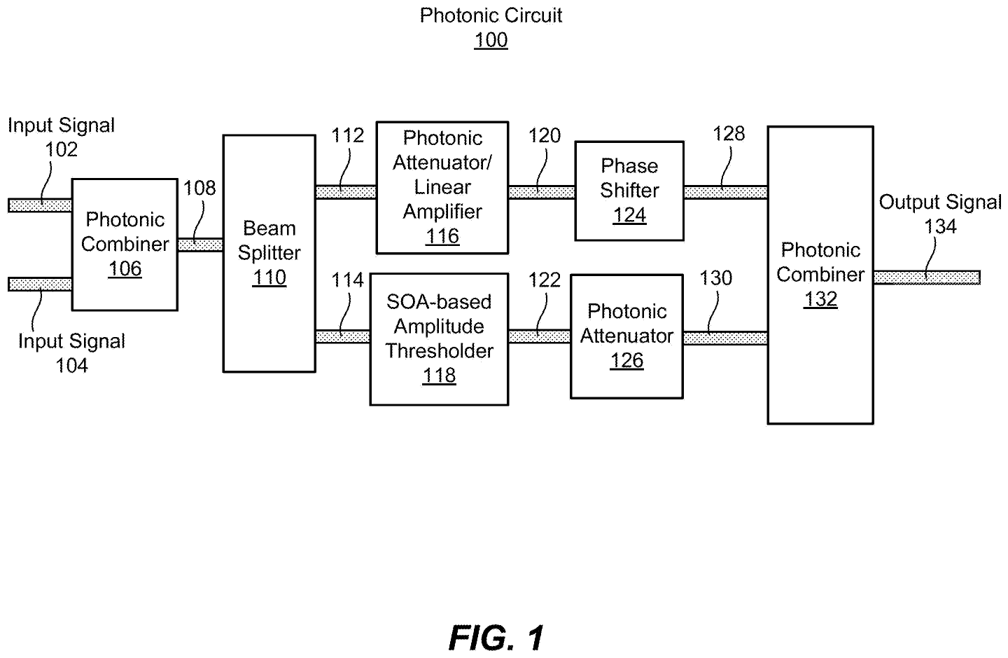

FIG. 1 illustrates an example cascadable photonic circuit 100 that includes a semiconductor optical amplifier (SOA) based amplitude thresholder 118, in accordance with some embodiments. The photonic circuit 100 may include a photonic combiner 106, a beam splitter 110 coupled to an output port of the photonic combiner 106, a photonic attenuator/linear amplifier 116 coupled to a first output port of the beam splitter 110, the SOA-based amplitude thresholder 118 coupled to a second output port of the beam splitter 110, a phase shifter 124 connected to an output port of the photonic attenuator/linear amplifier 116, a photonic attenuator 126 coupled to an output port of the SOA-based amplitude thresholder 118, and a photonic combiner 132 connected to an output port of the phase shifter and an output port of the photonic attenuator 126. The photonic circuit 100 may generate a photonic output signal 134 as a logical function of photonic input signals 102, 104 (and, optionally, one or more additional photonic input signals). The photonic circuit 100 may be configured to operate as a nonlinear XOR photonic gate. Alternatively, or additionally, the photonic circuit 100 may be configured to operate as some other nonlinear photonic logic gate. The nonlinearity in the photonic circuit 100 may enable error-free cascadability of the protonic circuit 100 with other linear or nonlinear photonic gates. The photonic circuit 100 may include fewer or additional components not shown in FIG. 1.

The photonic combiner 106 may receive a pair of photonic input signals 102, 104 and generate a photonic signal 108 that represents a logical combination of the photonic input signals 102 and 104. Thus, the photonic combiner 106 may operate as a passive OR photonic logic gate. The photonic input signals 102, 104 may be light signals of corresponding input amplitudes (that each corresponds to logical “1” or logical “0”), corresponding input phases and/or corresponding input modes (i.e., input light spatial distribution and/or input wavelengths) injected into a set of input ports of the photonic combiner 106. The set of input ports of the photonic combiner 106 may represent, e.g., a set of waveguides, a set of waveguide polarizations, a set of waveguide modes, a set of light wavelengths, etc. The photonic signal 108 may be a light signal of corresponding output amplitudes (that each corresponds to logical “1” or logical “0”), corresponding output phase and/or corresponding output mode (i.e., output light spatial distribution and/or output wavelength) detected at an output port of the photonic combiner 106. The output port of the photonic combiner 106 may represent, e.g., a waveguide, a waveguide polarization, a waveguide mode, a light wavelength, a signal radiated by the photonic combiner 106, etc. The photonic combiner 106 may pass the photonic signal 108 to the beam splitter 110.

The beam splitter 110 may receive the photonic signal 108 at its input port. The input port of the beam splitter 110 may represent, e.g., a waveguide, a waveguide polarization, a waveguide mode, a light wavelength, etc. The beam splitter 110 is a passive photonic component that splits the received photonic signal 108 into two photonic signals 112, 114 representing components of the received photonic signal 108. Each photonic signal 112, 114 may be output at a respective output port of the beam splitter 110. A set of output ports of the beam splitter 110 may represent, e.g., a set of waveguides, a set of waveguide polarizations, a set of waveguide modes, a set of light wavelengths, signals radiated by the beam splitter 110, etc. The beam splitter 110 may pass the photonic signals 112 and 114 to the photonic attenuator/linear amplifier 116 and the SOA-based amplitude thresholder 118, respectively.

The photonic attenuator/linear amplifier 116 may receive the photonic signal 112 at its input port. The input port of the photonic attenuator/linear amplifier 116 may represent, e.g., a waveguide, a waveguide polarization, a waveguide mode, a light wavelength, etc. The photonic attenuator/linear amplifier 116 is a linear photonic component that generates a photonic signal 120 by attenuating (or amplifying) amplitudes of the received photonic signal 112. The attenuated/amplified photonic signal 120 may be output at an output port of the photonic attenuator/linear amplifier 116. The output port of the photonic attenuator/linear amplifier 116 may represent, e.g., a waveguide, a waveguide polarization, a waveguide mode, a light wavelength, a signal radiated by the photonic attenuator/linear amplifier 116, etc. The photonic attenuator/linear amplifier 116 may pass the attenuated/amplified photonic signal 120 to the phase shifter 124.

The phase shifter 124 may receive the attenuated/amplified photonic signal 120 at its input port. The input port of the phase shifter 124 may represent, e.g., a waveguide, a waveguide polarization, a waveguide mode, a light wavelength, etc. The phase shifter 124 is a passive photonic component that generates a photonic signal 128 by shifting a phase of the received attenuated/amplified photonic signal 120. For example, the phase shifter 124 may apply a phase shift of π radians to the attenuated/amplified photonic signal 120, i.e., the photonic signal 128 may represent an inverted version of the attenuated/amplified photonic signal 120. The phase-shifted photonic signal 128 may be output at an output port of the phase shifter 124. The output port of the phase shifter 124 may represent, e.g., a waveguide, a waveguide polarization, a waveguide mode, a light wavelength, a signal radiated by the phase shifter 124, etc. The phase shifter 124 may pass the phase-shifted photonic signal 128 to the photonic combiner 132.

The SOA-based amplitude thresholder 118 may receive the photonic signal 114 at its input port. The input port of the SOA-based amplitude thresholder 118 may represent, e.g., a waveguide, a waveguide polarization, a waveguide mode, a light wavelength, etc. The SOA-based amplitude thresholder 118 may be an active nonlinear photonic amplifier that generates a photonic signal 122 by saturating an amplitude of the received photonic signal 114 while being configured to operate in a single nonlinear region. The saturated photonic signal 122 may be output at an output port of the SOA-based amplitude thresholder 118. The output port of the SOA-based amplitude thresholder 118 may represent, e.g., a waveguide, a waveguide polarization, a waveguide mode, a light wavelength, a signal radiated by the SOA-based amplitude thresholder 118, etc. The SOA-based amplitude thresholder 118 may pass the saturated photonic signal 122 to the photonic attenuator 126.

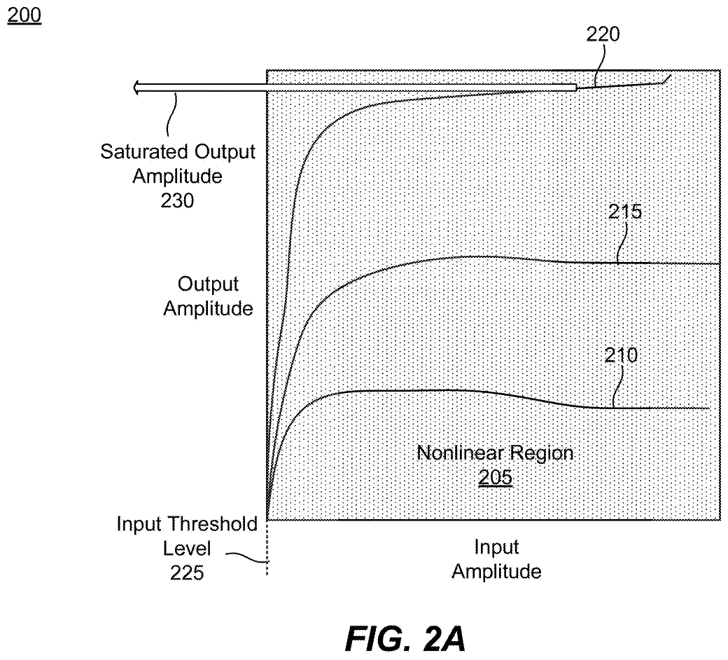

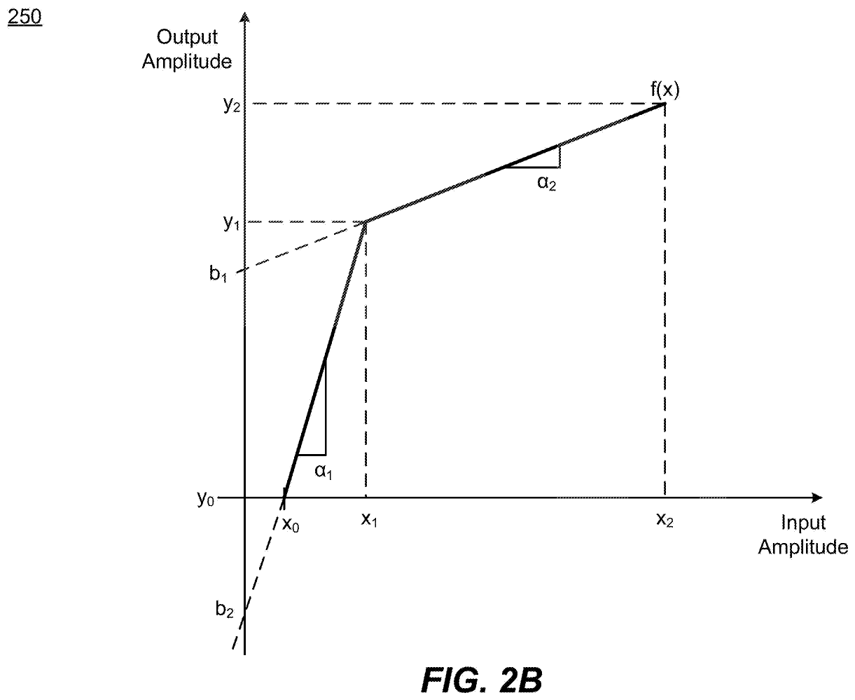

FIG. 2A illustrates an example graph 200 of nonlinear transfer functions of the SOA-based amplitude thresholder 118, in accordance with some embodiments. A transfer function of the SOA-based amplitude thresholder 118 represents a function that determines an “output amplitude” of the photonic signal 122 based on an “input amplitude” of the photonic signal 114. As shown in FIG. 2A, the SOA-based amplitude thresholder 118 operates in a single nonlinear region 205. The example graph 200 shows plots 210, 215 and 220 each representing a different transfer function of the SOA-based amplitude thresholder 118. Each transfer function 210, 215, 220 may be associated with a different saturation level of the SOA-based amplitude thresholder 118. For example, the transfer function 210 may be associated with a first saturation level (e.g., 0.3), the transfer function 210 may be associated with a second saturation level (e.g., 0.5) that is greater than the first saturation level, and the transfer function 215 may be associated with a third saturation level (e.g., 1.0) that is greater than the second saturation level.

The SOA-based amplitude thresholder 118 may be tuned to have a particular transfer function 210, 215, 220 that is associated with a respective saturation level. Thus, when the SOA-based amplitude thresholder 118 is tuned to have the transfer function 210, the “output amplitude” of the saturated photonic signal 122 equals to the first saturation level, if the “input amplitude” of the photonic signal 114 is greater than an input threshold level 225. Similarly, when the SOA-based amplitude thresholder 118 is tuned to have the transfer function 215, the “output amplitude” of the saturated photonic signal 122 equals to the second saturation level, if the “input amplitude” of the photonic signal 114 is greater than the input threshold level 225; and when the SOA-based amplitude thresholder 118 is tuned to have the transfer function 220, the “output amplitude” of the saturated photonic signal 122 equals to the third saturation level, if the “input amplitude” of the photonic signal 114 is greater than the input threshold level 225. As shown in FIG. 2A, when the SOA-based amplitude thresholder 118 is tuned to have the transfer function 220, an amplitude of the saturated photonic signal 122 is equal to a saturated output amplitude 230.

Note that the SOA-based amplitude thresholder 118 operates in the nonlinear region 205 when the “input amplitude” of the photonic signal 114 is greater than the input threshold level 225. When the “input amplitude” of the photonic signal 114 is below the input threshold level 225, the “input amplitude” of the photonic signal 114 may be processed by a linear region of the SOA-based amplitude thresholder 118 (not shown in FIG. 2A). In such a case, an amplitude of the photonic signal 122 generated by the SOA-based amplitude thresholder 118 may be equal to a gain level that the SOA-based amplitude thresholder 118 can achieve when operating in the linear region. The SOA-based amplitude thresholder 118 may be configured to reach the nonlinear region 205 for the input threshold level 225 of, e.g., less than 1.0. In such a case, higher levels of the “input amplitude” (e.g., “the input amplitude” of 2.0 and the input amplitude” of 1.0) may be thresholded to, e.g., the “output amplitude” of 1.0. However, lower levels of the “input amplitude” of the photonic signal 114 (e.g., less than or equal to 0.5) may not be thresholded by SOA-based amplitude thresholder 118 as the lower levels of the “input amplitude” belongs to the linear region of the SOA-based amplitude thresholder 118.

In one or more embodiments, the SOA-based amplitude thresholder 118 is tuned to have a particular transfer function 210, 215, 220, each associated with one or more different value of parameters in the nonlinear model of the SOA-based amplitude thresholder 118. In general, one or more parameters of photonic components in the photonic circuit 100 (e.g., attenuation levels of the photonic attenuator/linear amplifier 116 and the photonic attenuator 126) may be set such that to accommodate a particular transfer function 210, 215, 220 of the SOA-based amplitude thresholder 118. For an accurate operation of the photonic circuit 100 (e.g., XOR logic operation), the SOA-based amplitude thresholder 118 may be tuned to have a particular transfer function 210, 215, 220 such that “saturated amplitudes” of the photonic signal 122 are matched with “un-saturated amplitudes” of the photonic signal 120.

FIG. 2B illustrates an example generalized graph 250 of a transfer function of the SOA-based amplitude thresholder 118 represented as a piece-wise function, in accordance with some embodiments. The general nonlinearity of the SOA-based amplitude thresholder 118 may be approximated by a piece-wise function f(x) in FIG. 2B that has two slopes, i.e., the first slope α₁=(y₁−y₀)/(x₁−x₀) on a first interval of input amplitudes x∈[x₀, x₁], and the second slope α2=(y₂−y₁)/(x₂−x₁) on a second interval of input amplitudes x∈(x₁, x₂]. Thus, the transfer function of the SOA-based amplitude thresholder 118 may be defined by the piece-wise function f(x) given as:

$$f ( x ) = \{ \begin{matrix}{α}_{1} x + {b}_{1} & if x ∈ [ {x}_{0} , {x}_{1} ] \\ {α}_{2} x + {b}_{2} & if x ∈ [ {x}_{1} , {x}_{2} ]\end{matrix} , \qquad ( 1 )$$

where the values of b₁ and b₂ are defined as in FIG. 2B. Any of the transfer functions 210, 215, 220 in FIG. 2A can be approximated with a corresponding piece-wise function f(x) defined by Eq. (1). And, the SOA-based amplitude thresholder 118 may be tuned to have the transfer function as illustrated in FIG. 2B. Furthermore, the piece-wise function f(x) in FIG. 2B may be utilized to generate each of the transfer functions 210, 215, 220 shown in FIG. 2A.

Note that, in ideal case, it holds that α₁→1 and α₂→0; however, in general, α₁>>α₂. Thus, in general, it holds that y₂≈y₁, and the output amplitude value of y₂ (or y₁) may represent a saturated output amplitude generated by the SOA-based amplitude thresholder 118 (e.g., an amplitude of the saturated photonic signal 122). The input amplitude value x greater than or equal to x₀ and lower than x₁ may represent an input threshold level for operating the SOA-based amplitude thresholder 118 in a linear region defined by the piece-wise function f(x). The input amplitude value of x₁ may represent an input threshold level for operating the SOA-based amplitude thresholder 118 in a nonlinear region defined by the piece-wise function f(x). The SOA-based amplitude thresholder 118 may operate in the nonlinear region defined by the piece-wise function f(x) when the “input amplitude” of the photonic signal 114 is greater than the threshold level of x₁ and less than or equal to x₂, where the input amplitude value of x₂ represents a largest input amplitude value for which the SOA-based amplitude thresholder 118 is configured.

In some embodiments, the SOA-based amplitude thresholder 118 is replaced with a passive nonlinear optical amplitude thresholder. The passive nonlinear optical amplitude thresholder used within the photonic circuit 100 instead of the SOA-based amplitude thresholder 118 may be a resonator-based nonlinear optical device that translates small refractive perturbations into large changes in light propagation. Low intensity light may be fully or partially blocked by the passive nonlinear optical amplitude thresholder, while high intensity light may be fully or partially transmitted by the passive nonlinear optical amplitude thresholder, and vice-versa. The passive nonlinear optical amplitude thresholder may be silicon-based, e.g., made of Silicon or Silicon Nitride, or non-Silicon based. In one or more embodiments, the nonlinear optical amplitude thresholder is implemented as a ring resonator (or racetrack resonator). In one or more other embodiments, the passive nonlinear optical amplitude thresholder is implemented as a fully inverse-designed resonator. In some embodiments, the passive nonlinear optical amplitude thresholder is implemented as another form of photonic resonator.

The photonic attenuator 126 may receive the saturated photonic signal 122 generated by the SOA-based amplitude thresholder 118 at an input port of the photonic attenuator 126. The input port of the photonic attenuator 126 may represent, e.g., a waveguide, a waveguide polarization, a waveguide mode, a light wavelength, etc. The photonic attenuator 126 is a passive linear photonic component that generates a photonic signal 130 by attenuating amplitudes of the saturated photonic signal 122. The attenuated photonic signal 130 may be output at an output port of the photonic attenuator 126. The output port of the photonic attenuator 126 may represent, e.g., a waveguide, a waveguide polarization, a waveguide mode, a light wavelength, a signal radiated by the photonic attenuator 126, etc. The photonic attenuator 126 may pass the attenuated photonic signal 130 to the photonic combiner 132.

The photonic combiner 132 may receive, at its first input port, the phase-shifted photonic signal 128 generated by the phase shifter 124. The photonic combiner 132 may further receive, at its second input port, the attenuated photonic signal 130 generated by the photonic attenuator 126. The set of input ports of the photonic combiner 132 may represent, e.g., a set of waveguides, a set of waveguide polarizations, a set of waveguide modes, a set of light wavelengths, etc. The photonic combiner 132 may generate a photonic output signal 134 by combining the phase-shifted photonic signal 128 and the attenuated photonic signal 130. Thus, the photonic combiner 132 may operate as a passive OR photonic logic gate. The photonic output signal 134 may be output at an output port of the photonic combiner 132. The output port of the photonic combiner 132 may represent, e.g., a waveguide, a waveguide polarization, a waveguide mode, a light wavelength, a signal radiated by the photonic combiner 132, etc.

In some embodiments, the photonic output signal 134 generated by the photonic combiner 132 represents a resulting light signal of an XOR logic operation between the photonic input signal 102 and the photonic input signal 104. Hence, in such cases, the photonic circuit 100 operates as a nonlinear XOR photonic logic gate. Since the photonic output signal 134 together with the photonic input signals 102 and 104 form an accurate truth table of an XOR photonic logic gate (i.e., no errors are propagated to the photonic output port of the photonic circuit 100), the photonic circuit 100 is cascadable, i.e., the photonic circuit 100 can be directly connected with other (same or different) photonic circuits within a photonic processor.

### Example Cascadable Photonic Gate

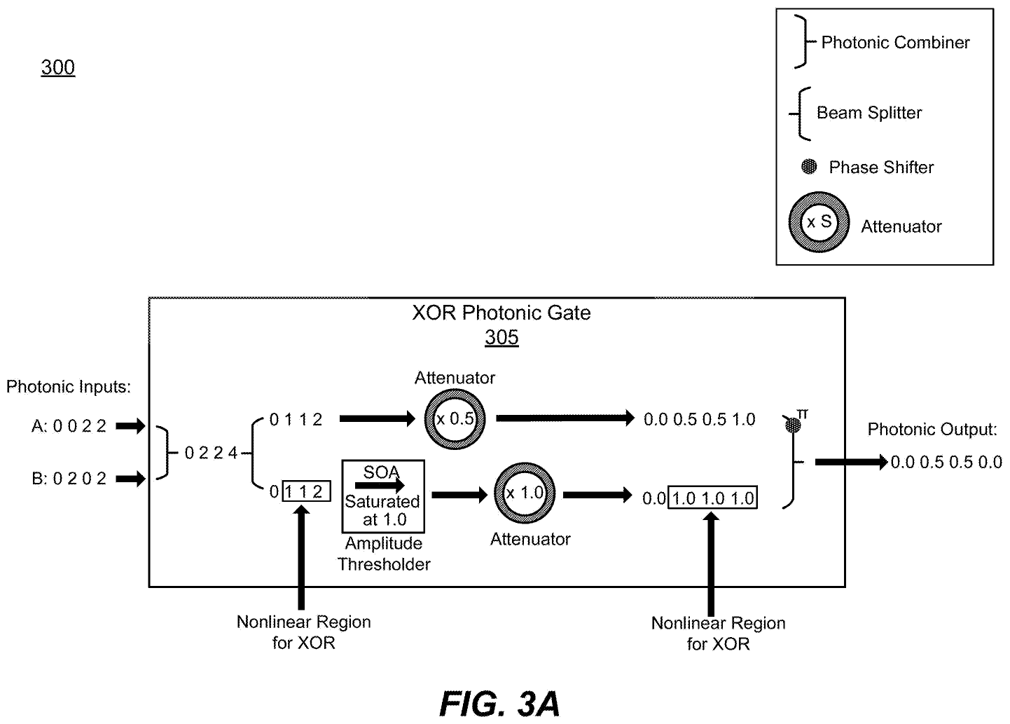

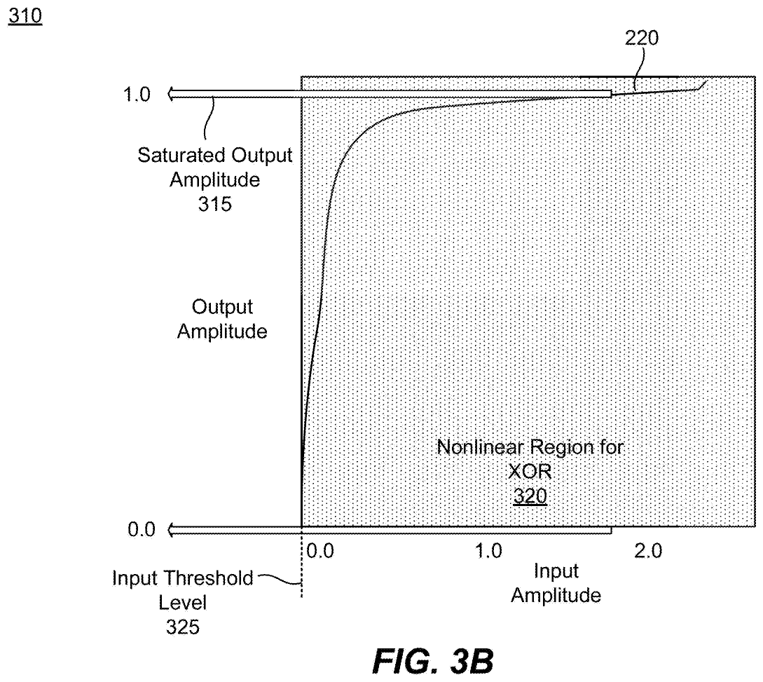

FIG. 3A illustrates an example XOR logic operation 300 of the photonic circuit 100, in accordance with some embodiments. An XOR photonic gate 305 shown in FIG. 3A represents an embodiment of the photonic circuit 100. The XOR photonic gate 305 receives a pair of photonic input signals A and B. The photonic input signals A and B may be light signals of corresponding input amplitudes (that correspond to logical “1” or logical “0”), corresponding input phases and/or corresponding input modes (i.e., input light spatial distribution and/or input wavelengths) injected into a set of input ports of a first photonic combiner of the XOR photonic gate 305 (e.g., the photonic combiner 106). For example, the photonic input signal A has a variable amplitude over time, having the amplitude sequence of “0 0 2 2” such that the photonic input signal A corresponds to the logical sequence of “0 0 1 1”; and the photonic input signal B has a variable amplitude over time having the amplitude sequence of “0 2 0 2” such that the photonic input signal B corresponds to the logical sequence of “0 1 0 1”. The photonic input signals A and B may represent examples of the photonic input signals 102 and 104.

The first photonic combiner of the XOR photonic gate 305 generates a photonic signal having an amplitude sequence of “0 2 2 4” by combining the photonic input signal A and the photonic input signal B. A beam splitter of the XOR photonic gate 305 (e.g., the beam splitter 110) splits the amplitude sequence of “0 2 2 4” into a pair of photonic signals, each having the amplitude sequence of “0 1 1 2”. A first photonic signal with the amplitude sequence of “0 1 1 2” generated by the beam splitter is attenuated (e.g., via the photonic attenuator/linear amplifier 116) by the scaling factor S of 0.5 to generate an attenuated photonic signal having the amplitude sequence of “0.0 0.5 0.5 1.0”.

A second photonic signal with the amplitude sequence of “0 1 1 2” generated by the beam splitter is input into an amplitude thresholder of the XOR photonic gate 305 (e.g., the SOA-based amplitude thresholder 118). FIG. 3B illustrates an example graph 310 of a transfer function of the amplitude thresholder of the XOR photonic gate 305, in accordance with some embodiments. It may be observed by comparing the graphs 200 and 310 that the amplitude thresholder of the XOR photonic gate 305 is tuned to have the transfer function 220 associated with the third saturation level. In the exemplary case of FIGS. 3A-3B, the third saturation level corresponds to a saturated output amplitude 315 that is equal to “1.0”. Thus, when inputting the second photonic signal having the amplitude sequence of “0 1 1 2” into the amplitude thresholder of the XOR photonic gate 305, the amplitude thresholder generates a saturated photonic signal having the amplitude sequence of “0.0 1.0 1.0 1.0”. The amplitude thresholder operates in a nonlinear region 320 when the “input amplitude” is greater than an input threshold level 325 (e.g., equal to 0.0) and saturates the “input amplitude” to the saturated output amplitude 315 that is equal to “1.0”. When the “input amplitude” is equal to the input threshold level 325 of “0.0”, the “output amplitude” remains unchanged, i.e., an input amplitude of “0.0” remains an amplitude of “0.0” at the output of the amplitude thresholder of the XOR photonic gate 305.

The saturated photonic signal having the amplitude sequence of “0.0 1.0 1.0 1.0” may be attenuated (e.g., by the photonic attenuator 126) before being input to a second photonic combiner of the XOR photonic gate 305 (e.g., the photonic combiner 132). In the example 300 of FIG. 3A, the saturated photonic signal having the amplitude sequence of “0.0 1.0 1.0 1.0” is not attenuated, e.g., the scaling factor S of 1.0 is applied to the saturated photonic signal. Before being input to the second photonic combiner of the XOR photonic gate 305, the attenuated photonic signal having the amplitude sequence of “0.0 0.5 0.5 1.0” is phase-shifted (e.g., via the phase shifter 124) by π radians to obtain a phase-shifted photonic signal having the amplitude sequence of “0.0−0.5−0.5−1.0”. The second photonic combiner of the XOR photonic gate 305 (e.g., the photonic combiner 132) combines the phase-shifted photonic signal having the amplitude sequence of “0.0−0.5−0.5−1.0” with the saturated (and, optionally, attenuated) photonic signal having the amplitude sequence of “0.0 1.0 1.0 1.0” to generate a photonic output signal having the amplitude sequence of “0.0 0.5 0.5 0.0”. Note that operations of the second photonic combiner and the phase shifter are equivalent to subtracting the attenuated photonic signal having the amplitude sequence of “0.0 0.5 0.5 1.0” from the saturated photonic signal having the amplitude sequence of “0.0 1.0 1.0 1.0”.

The photonic output signal with the amplitude sequence of “0.0 0.5 0.5 0.0” corresponds to the logical sequence of “0 1 1 0”, which represents a result of XOR logic operation between the photonic input signal A and the photonic input signal B. The photonic output signal having the amplitude sequence of “0.0 0.5 0.5 0.0” may be an example of the photonic output signal 134. It should be understood that example parameters of the XOR photonic gate 305 shown in FIG. 3A (e.g., phase shifting value, scaling factors of attenuators, and saturation level of the amplitude thresholder) represent one possible embodiment of the photonic circuit 100, and that other example parameters are possible that result in the XOR logic operation or some other logic operation of the photonic circuit 100.

The general mathematical model for the XOR photonic gate 305 can be derived using the notion of electric fields. The photonic input signal A can be defined as a sequence of strengths of electric field over time, E₁¹, E₁², E₁³, E₁⁴; and the photonic input signal B can be defined as a sequence of strengths of electric field over time, E₂¹, E₂², E₂³, E₂⁴, where {E₁³, E₁⁴, E₂², E₂⁴}>{E₁¹, E₁², E₂¹, E₂³}, and, ideally, E₁¹=E₂¹=0. The first photonic combiner of the XOR photonic gate 305 generates a combined photonic signal having a sequence of strengths of electric field

$$\frac{{E}_{1}^{1} + {E}_{2}^{1}}{\sqrt{2}} , \frac{{E}_{1}^{2} + {E}_{2}^{2}}{\sqrt{2}} , \frac{{E}_{1}^{3} + {E}_{2}^{3}}{\sqrt{2}} , \frac{{E}_{1}^{4} + {E}_{2}^{4}}{\sqrt{2}}$$

by combining the photonic input signal A and the photonic input signal B. The beam splitter of the XOR photonic gate 305 splits the combined photonic signal into a pair of photonic signals, each having a sequence of strengths of electric field

$$\frac{{E}_{1}^{1} + {E}_{2}^{1}}{2} , \frac{{E}_{1}^{2} + {E}_{2}^{2}}{2} , \frac{{E}_{1}^{3} + {E}_{2}^{3}}{2} , \frac{{E}_{1}^{4} + {E}_{2}^{4}}{2} .$$

The first photonic signal having the sequence of strengths of electric field

$$\frac{{E}_{1}^{1} + {E}_{2}^{1}}{2} , \frac{{E}_{1}^{2} + {E}_{2}^{2}}{2} , \frac{{E}_{1}^{3} + {E}_{2}^{3}}{2} , \frac{{E}_{1}^{4} + {E}_{2}^{4}}{2}$$

is then attenuated (or amplified) by a factor A₁ to generate an attenuated/amplified photonic signal having a sequence of strengths of electric field

$${A}_{1} ( \frac{{E}_{1}^{1} + {E}_{2}^{1}}{2} , \frac{{E}_{1}^{2} + {E}_{2}^{2}}{2} , \frac{{E}_{1}^{3} + {E}_{2}^{3}}{2} , \frac{{E}_{1}^{4} + {E}_{2}^{4}}{2} ) .$$

The second photonic signal having the sequence of strengths of electric field

$$\frac{{E}_{1}^{1} + {E}_{2}^{1}}{2} , \frac{{E}_{1}^{2} + {E}_{2}^{2}}{2} , \frac{{E}_{1}^{3} + {E}_{2}^{3}}{2} , \frac{{E}_{1}^{4} + {E}_{2}^{4}}{2}$$

is first saturated by the amplitude thresholder that operates in a nonlinear region having a saturated output strength of electric field equal to

$$\frac{{E}_{1}^{2} + {E}_{2}^{2}}{2} .$$

After that, the saturated photonic signal generated by the amplitude thresholder is attenuated by a factor A₂ to generate a saturated and attenuated photonic signal having a sequence of strengths of electric field

$${A}_{2} ( \frac{{E}_{1}^{1} + {E}_{2}^{1}}{2} , \frac{{E}_{1}^{2} + {E}_{2}^{2}}{2} , \frac{{E}_{1}^{2} + {E}_{2}^{2}}{2} , \frac{{E}_{1}^{2} + {E}_{2}^{2}}{2} ) .$$

The factors A₁ and A₂ may be set such that A₁<A₂ and

$${A}_{1} \frac{{E}_{1}^{4} + {E}_{2}^{4}}{2} = {A}_{2} \frac{{E}_{1}^{2} + {E}_{2}^{2}}{2} .$$

Furthermore, conditions that may be enforced are: E₁³=E₁⁴=E₂²=E₂⁴ and E₁¹=E₁²=E₂¹=E₂³.

The attenuated/amplified photonic signal having the sequence of strengths of electric field

$${A}_{1} ( \frac{{E}_{1}^{1} + {E}_{2}^{1}}{2} , \frac{{E}_{1}^{2} + {E}_{2}^{2}}{2} , \frac{{E}_{1}^{3} + {E}_{2}^{3}}{2} , \frac{{E}_{1}^{4} + {E}_{2}^{4}}{2} )$$

is phase-shifted by π radians before being input into the second photonic combiner of the XOR photonic gate 305. The second photonic combiner combines the phase-shifted attenuated/amplified photonic signal with the saturated and attenuated photonic signal to generate the photonic output signal having a sequence of strengths of electric field 0,

$$( {A}_{2} - {A}_{1} ) \frac{{E}_{1}^{2} + {E}_{2}^{2}}{2 \sqrt{2}} , ( {A}_{2} - {A}_{1} ) \frac{{E}_{1}^{2} + {E}_{2}^{2}}{2 \sqrt{2}} , 0 ,$$

where the strength of electric field

$$( {A}_{2} - {A}_{1} ) \frac{{E}_{1}^{2} + {E}_{2}^{2}}{2 \sqrt{2}}$$

corresponds to the high logic value. Thus, the generated photonic output signal corresponds to the XOR logic function between the photonic input signals A and B.

### Example Process Flow

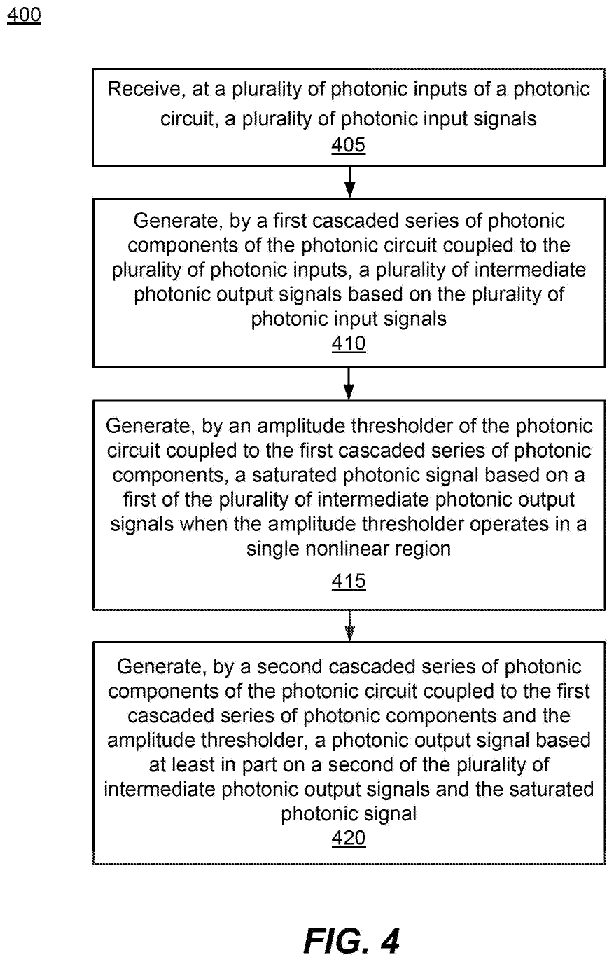

FIG. 4 is a flowchart illustrating an example method 400 for operating a photonic circuit with a SOA-based amplitude thresholder for correction of amplitude and phase errors, in accordance with some embodiments. The operations of method 400 may be performed at, e.g., the photonic circuit 100. The photonic circuit may be part of a photonic processor that includes a cascaded connection of the photonic circuit and at least one other photonic component that includes the photonic circuit (e.g., cascaded connection of at least two photonic circuits). The photonic circuit may be deployed in a computing system (e.g., a photonic processor) that can further include a non-transitory computer-readable storage medium (e.g., optical, electrical, or electro-optical memory) for storing computer-executable instructions and data. The computing system may be implemented as a silicon photonics platform.

The photonic circuit receives 405, at a plurality of photonic inputs, a plurality of photonic input signals (e.g., two photonic input signals). The photonic circuit generates 410, by a first cascaded series of photonic components coupled to the plurality of photonic inputs, a plurality of intermediate photonic output signals (e.g., the photonic signals 112, 114) based on the plurality of photonic input signals. The first cascaded series of photonic components may include a cascaded connection of a photonic combiner (e.g., the photonic combiner 106) and a beam splitter (e.g., the beam splitter 110).

The photonic circuit generates 415, by an amplitude thresholder (e.g., the SOA-based amplitude thresholder 130) coupled to the first cascaded series of photonic components, a saturated photonic signal based on a first of the plurality of intermediate photonic output signals (e.g., the photonic signal 114) when the amplitude thresholder operates in a single nonlinear region. The amplitude thresholder may be coupled to an output of the beam splitter (e.g., the beam splitter 110). The amplitude thresholder may saturate amplitudes of a photonic signal generated at an output of the beam splitter when generating the saturated photonic signal. The amplitude thresholder may be configured to operate in the single nonlinear region as an active nonlinear SOA-based amplitude thresholder. Alternatively, the amplitude thresholder may be configured to operate as a passive nonlinear optical amplitude thresholder. The amplitude thresholder may be configured to saturate photonic signals of different amplitudes that are input in the amplitude thresholder to a defined amplitude level. The amplitude thresholder may be configured to generate the saturated photonic signal that is equal to the defined amplitude level when the first intermediate photonic output signal is greater than an input threshold value (e.g., zero amplitude level). The amplitude thresholder may be configured to saturate the photonic signals of different amplitudes to the defined amplitude level of a plurality of amplitude saturation levels, each of the plurality of amplitude saturation levels associated with one or more different values of one or more parameters of a model of the amplitude thresholder.

The photonic circuit generates 420, by a second cascaded series of photonic components coupled to the first cascaded series of photonic components and the amplitude thresholder, a photonic output signal based at least in part on a second of the plurality of intermediate photonic output signals (e.g., the photonic signal 114) and the saturated photonic signal (e.g., the photonic signal 122). The second cascaded series of photonic components may include a cascaded connection of a first photonic attenuator (e.g., the photonic attenuator/linear amplifier 116), a phase shifter (e.g., the phase shifter 124), a second photonic attenuator (e.g., the photonic attenuator 126) and a photonic combiner (e.g., the photonic combiner 132). The amplitude thresholder may be coupled to an input of the second photonic attenuator. The second photonic attenuator may be configured to attenuate the saturated photonic signal generated by the amplitude thresholder. The photonic output signal may correspond to an output of an XOR function of the plurality of photonic input signals.

Embodiments of the present disclosure are directed to a cascadable photonic circuit that utilizes a nonlinear photonic component (e.g., SOA-based amplitude thresholder) for correction of errors (e.g., amplitude errors and/or phase errors) produced by a passive photonic logic within the photonic circuit. The photonic circuit presented herein produces correct output results and can be directly cascaded with other photonic circuits within a photonic processor.

### ADDITIONAL CONSIDERATIONS

The disclosed configurations beneficially provide for efficient design of photonic logic gates while greatly reducing a number of required numerical design simulations.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to effectively convey the substance of their work to others skilled in the art. While described functionally, computationally, or logically, these operations are understood to be implemented by computer programs or equivalent electrical circuits, microcode, or the like. Furthermore, at times, it has also proven convenient to refer to these arrangements of operations as modules without loss of generality. The described operations and associated modules can be embodied in software, firmware, hardware, or some combination thereof.

Any steps, operations, or processes described herein can be performed or implemented with one or more hardware or software modules, alone or in combination with other devices. In one embodiment, a software module is implemented with a computer program product comprising a computer-readable medium containing computer program code, which a computer processor can execute for performing any or all of the steps, operations, or processes described herein.

Embodiments of the disclosure can also relate to an apparatus for performing the operations herein. This apparatus can be specially constructed for the required purposes, and/or it can comprise a general-purpose computing device selectively activated or reconfigured by a computer program stored in the computer. Such a computer program can be stored in a non-transitory, tangible computer-readable storage medium or any media suitable for storing electrical instructions coupled to a computer system bus. Furthermore, any computing systems referred to in the specification can include a single processor or architectures employing multiple processor designs for increased computing capability.

Some embodiments of the present disclosure can further relate to a system comprising a processor, at least one computer processor, and a non-transitory computer-readable storage medium. The storage medium can store computer-executable instructions, which, when executed by the compiler operating on at least one computer processor, cause at least one computer processor to be operable for performing the operations and techniques described herein.

Finally, the language used in the specification has been principally selected for readability and instructional purposes, and it has not been selected to delineate or circumscribe the inventive subject matter. It is therefore intended that the scope of the disclosure be limited not by this detailed description but rather by any claims that issue on an application based hereon. Accordingly, the disclosure of the embodiments is intended to be illustrative, but not to limit the scope of the disclosure, which is set forth in the following claims.

What is claimed is:

1. A photonic circuit, comprising:
a plurality of photonic inputs configured to receive a plurality of photonic input signals;
a first cascaded series of photonic components coupled to the plurality of photonic inputs, the first cascaded series of photonic components configured to generate a plurality of intermediate photonic output signals based on the plurality of photonic input signals;
an amplitude thresholder coupled to the first cascaded series of photonic components, the amplitude thresholder configured to generate a saturated photonic signal based on a first of the plurality of intermediate photonic output signals when the amplitude thresholder operates in a single nonlinear region; and
a second cascaded series of photonic components coupled to the first cascaded series of photonic components and the amplitude thresholder, the second cascaded series of photonic components configured to generate a photonic output signal based at least in part on a second of the plurality of intermediate photonic output signals and the saturated photonic signal.

2. The photonic circuit of claim 1, wherein the first cascaded series of photonic components comprises a cascaded connection of a first photonic combiner and a beam splitter.

3. The photonic circuit of claim 2, wherein the amplitude thresholder is coupled to an output of the beam splitter.

4. The photonic circuit of claim 1, wherein the second cascaded series of photonic components comprises a cascaded connection of a first photonic attenuator, a phase shifter, a second photonic attenuator and a photonic combiner.

5. The photonic circuit of claim 4, wherein the amplitude thresholder is coupled to an input of the second photonic attenuator.

6. The photonic circuit of claim 1, wherein the amplitude thresholder is an active nonlinear semiconductor optical amplifier (SOA) based amplitude thresholder.

7. The photonic circuit of claim 1, wherein the amplitude thresholder is a passive nonlinear optical amplitude thresholder.

8. The photonic circuit of claim 1, wherein the amplitude thresholder is configured to saturate photonic signals of different amplitudes that are input in the amplitude thresholder to a defined amplitude level.

9. The photonic circuit of claim 8, wherein the amplitude thresholder is configured to generate the saturated photonic signal that is equal to the defined amplitude level when the first intermediate photonic output signal is greater than an input threshold value.

10. The photonic circuit of claim 1, wherein the photonic output signal corresponds to an output of an XOR function of the plurality of photonic input signals.

11. The photonic circuit of claim 1, wherein the photonic circuit is part of a photonic processor comprising a cascaded connection of the photonic circuit and at least one other photonic component that includes the photonic circuit.

12. A non-transitory computer-readable storage medium comprising stored instructions that, when executed by at least one processor, cause the at least one processor to:
instruct a plurality of photonic inputs of a photonic circuit to receive a plurality of photonic input signals;
instruct a first cascaded series of photonic components of the photonic circuit coupled to the plurality of photonic inputs to generate a plurality of intermediate photonic output signals based on the plurality of photonic input signals;
instruct an amplitude thresholder of the photonic circuit coupled to the first cascaded series of photonic components to generate a saturated photonic signal based on a first of the plurality of intermediate photonic output signals when the amplitude thresholder operates in a single nonlinear region; and
instruct a second cascaded series of photonic components of the photonic circuit coupled to the first cascaded series of photonic components and the amplitude thresholder to generate a photonic output signal based at least in part on a second of the plurality of intermediate photonic output signals and the saturated photonic signal.

13. The computer-readable storage medium of claim 12, wherein the first cascaded series of photonic components comprises a cascaded connection of a photonic combiner and a beam splitter, and the stored instructions comprise further stored instructions that, when executed, cause the at least one processor to:
instruct the amplitude thresholder to saturate amplitudes of a photonic signal generated at an output of the beam splitter when generating the saturated photonic signal.

14. The computer-readable storage medium of claim 12, wherein the second cascaded series of photonic components comprises a cascaded connection of a first photonic attenuator, a phase shifter, a second photonic attenuator and a photonic combiner, and the stored instructions comprise further stored instructions that, when executed, cause the at least one processor to:
instruct the second photonic attenuator to attenuate the saturated photonic signal generated by the amplitude thresholder.

15. The computer-readable storage medium of claim 12, wherein the stored instructions comprise further stored instructions that, when executed, cause the at least one processor to:
configure the amplitude thresholder to operate as an active nonlinear semiconductor optical amplifier (SOA) based amplitude thresholder.

16. The computer-readable storage medium of claim 12, wherein the stored instructions comprise further stored instructions that, when executed, cause the at least one processor to:
configure the amplitude thresholder to operate as a passive nonlinear optical amplitude thresholder.

17. The computer-readable storage medium of claim 12, wherein the stored instructions comprise further stored instructions that, when executed, cause the at least one processor to:
configure the amplitude thresholder to saturate photonic signals of different amplitudes that are input in the amplitude thresholder to a defined amplitude level.

18. The computer-readable storage medium of claim 17, wherein the stored instructions comprise further stored instructions that, when executed, cause the at least one processor to:
instruct the amplitude thresholder to generate the saturated photonic signal that is equal to the defined amplitude level when the first intermediate photonic output signal is greater than an input threshold value.

19. The computer-readable storage medium of claim 17, wherein the stored instructions comprise further stored instructions that, when executed, cause the at least one processor to:
configure the amplitude thresholder to saturate the photonic signals of different amplitudes to the defined amplitude level of a plurality of amplitude saturation levels, each of the plurality of amplitude saturation levels associated with one or more different values of one or more parameters of a model of the amplitude thresholder.

20. A method comprising:
receiving, at a plurality of photonic inputs of a photonic circuit, a plurality of photonic input signals;
generating, by a first cascaded series of photonic components of the photonic circuit coupled to the plurality of photonic inputs, a plurality of intermediate photonic output signals based on the plurality of photonic input signals;
generating, by an amplitude thresholder of the photonic circuit coupled to the first cascaded series of photonic components, a saturated photonic signal based on a first of the plurality of intermediate photonic output signals when the amplitude thresholder operates in a single nonlinear region; and
generating, by a second cascaded series of photonic components of the photonic circuit coupled to the first cascaded series of photonic components and the amplitude thresholder, a photonic output signal based at least in part on a second of the plurality of intermediate photonic output signals and the saturated photonic signal.
